(19) United States
(12) Patent Application Publication
(10) Pub. No.: US 2023/0147088 A1
(43) Pub. Date: May 11, 2023

(54) DETECTION APPARATUS

(71) Applicant: NEC Corporation, Minato-ku, Tokyo (JP)

(72) Inventors: Shihono Mochizuki, Tokyo (JP); Yohei Itou, Tokyo (JP); Satoshi Terasawa, Tokyo (JP)

(73) Assignee: NEC Corporation, Minato-ku, Tokyo (JP)

(21) Appl. No.: 17/911,178

(22) PCT Filed: Mar. 30, 2020
(86) PCT No.: PCT/JP2020/014484

§ 371 Date: Sep. 13, 2022

(51) Int. Cl. G06V 40/16; H04N 23/611; G06V 10/22; H04N 23/69; H04N 23/90

(52) U.S. Cl. CPC G06V 40/166; G06V 40/171; G06V 40/172; H04N 23/611; G06V 10/22; H04N 23/69; H04N 23/90

(57) ABSTRACT

A detection apparatus includes: a detection unit configured to perform detection of a face region based on image data acquired by a predetermined imaging device; and a setting change unit configured to change setting for performing a face region detection process with image data acquired by another imaging device, based on a result of the detection by the detection unit.

### TECHNICAL FIELD

The present invention relates to a detection apparatus, a detection method, and a recording medium.

### BACKGROUND ART

An authentication technique such as face authentication, which is detecting a face region and performing authentication based on a feature value of the detected face region, is known.

For example, Patent Document 1 describes one of the techniques used to detect a face region. Patent Document 1 describes an image pickup device (imaging device) that includes a detection determination means, a correction means, a calculation means, and a cancel determination means. According to Patent Document 1, the detection determination means determines whether or not a subject region can be detected based on a plurality of types of classifiers. The correction means performs a correction process on image data when it is determined that a subject region cannot be detected. The cancel determination means compares the results calculated by the calculation means that calculates the degrees of similarity between the image data before and after the correction and the classifiers, and determines whether or not to cancel the correction process based on the results of the comparison.
Patent Document 1: Japanese Unexamined Patent Application Publication No. JP-A 2013-198013

As described in Patent Document 1, there is a method of correcting image data when a region such as a face region cannot be detected by a detection means. However, in a case where a target is caught by a camera for a short time, there is a possibility that even if correction of the image data, for example, by adjustment of the parameter of the camera acquiring image data is intended, the target is out of the angle of view during the adjustment. As a result, failure to detect a face region may occur.

Thus, there has been a problem that it is difficult to inhibit failure to detect a face region.

### SUMMARY

Accordingly, an object of the present invention is to provide a detection apparatus, a detection method, and a recording medium which solve the problem that it is difficult to inhibit failure to detect a face region.

In order to achieve the object, a detection method as an aspect of the present disclosure is a detection method executed by a detection apparatus. The detection method includes: performing detection of a face region based on image data acquired by a predetermined imaging device; and changing setting for performing a face region detection process with image data acquired by another imaging device, based on a result of the detection.

Further, a detection apparatus as another aspect of the present disclosure includes: a detection unit configured to perform detection of a face region based on image data acquired by a predetermined imaging device; and a setting change unit configured to change setting for performing a face region detection process with image data acquired by another imaging device, based on a result of the detection by the detection unit.

Further, a recording medium as another aspect of the present disclosure is a non-transitory computer-readable recording medium having a program recorded thereon. The program includes instructions for causing a detection apparatus to realize: a detection unit configured to perform detection of a face region based on image data acquired by a predetermined imaging device; and a setting change unit configured to change setting for performing a face region detection process with image data acquired by another imaging device, based on a result of the detection by the detection unit.

The configurations as described above make it possible to provide a detection apparatus, a detection method, and a recording medium which can inhibit failure to detect a face region.

### BRIEF DESCRIPTION OF DRAWINGS

FIG. 1 is a view showing an example of a configuration of a face authentication system in a first example embodiment of the present disclosure;

FIG. 2 is a block diagram showing an example of a configuration of a face authentication apparatus shown in FIG. 1;

FIG. 3 is a view showing an example of image information shown in FIG. 2;

FIG. 4 is a view showing an example of posture information shown in FIG. 2;

FIG. 5 is a view for describing processing by a face region estimation unit;

FIG. 6 is a block diagram showing an example of a configuration of a camera shown in FIG. 1;

FIG. 7 is a flowchart showing an example of an operation of the face authentication apparatus in the first example embodiment of the present disclosure;

FIG. 8 is a view showing an example of a configuration of a face authentication system in a second example embodiment of the present disclosure;

FIG. 9 is a block diagram showing an example of a configuration of a face authentication apparatus shown in FIG. 8;

FIG. 10 is a view for showing an example of processing by a move destination estimation unit shown in FIG. 9;

FIG. 11 is a flowchart showing an example of an operation of the face authentication apparatus in the second example embodiment of the present disclosure;

FIG. 12 is a block diagram showing another example of the configuration of the face authentication apparatus in the second example embodiment of the present disclosure;

FIG. 13 is a view showing an example of a configuration of a face authentication system in a third example embodiment of the present disclosure;

FIG. 14 is a block diagram showing an example of a configuration of a face authentication apparatus shown in FIG. 13;

FIG. 15 is a view showing an example of authentication-related information shown in FIG. 14;

FIG. 16 is a block diagram showing an example of a configuration of a camera shown in FIG. 13;

FIG. 17 is a flowchart showing an example of an operation of the face authentication apparatus in the third example embodiment of the present disclosure;

FIG. 18 is a view showing an example of a hardware configuration of a detection apparatus in a fourth example embodiment of the present disclosure; and

FIG. 19 is a block diagram showing an example of a configuration of the detection apparatus shown in FIG. 18.

### EXAMPLE EMBODIMENTS

### First Example Embodiment

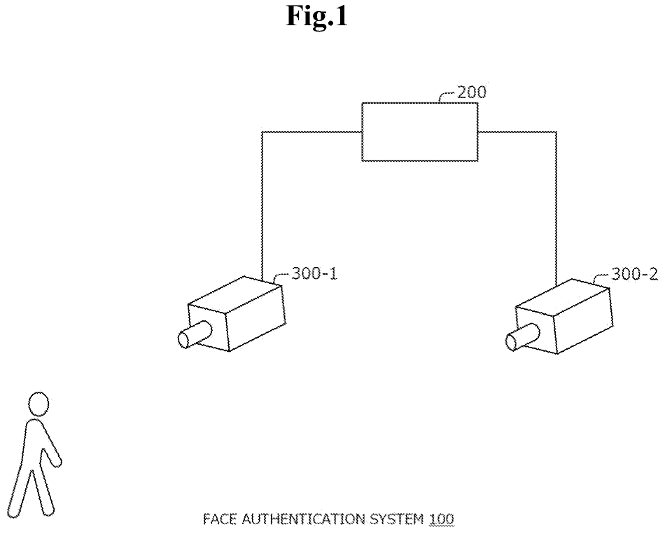

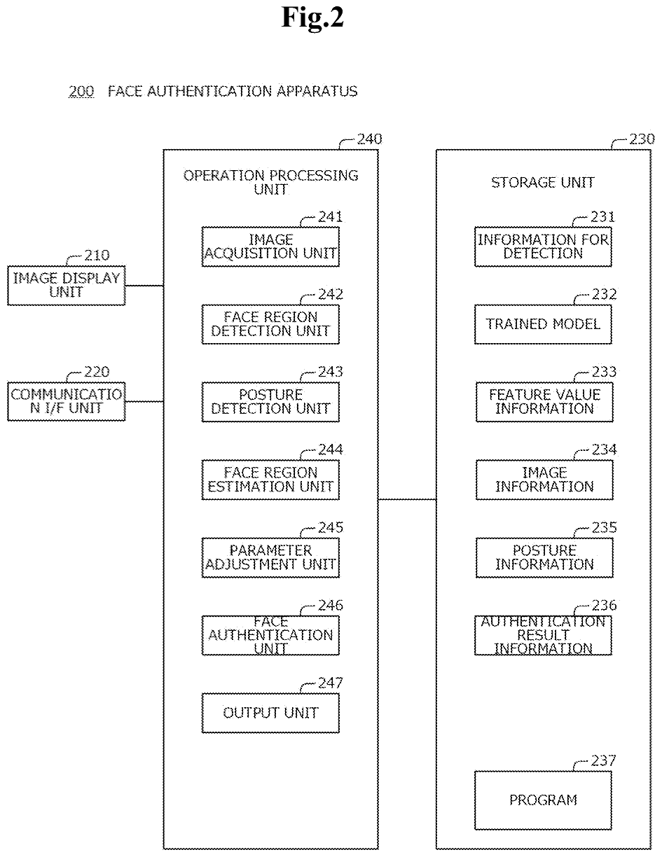

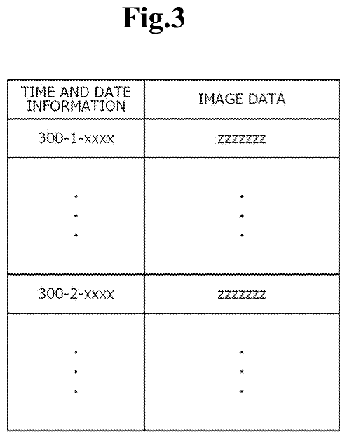

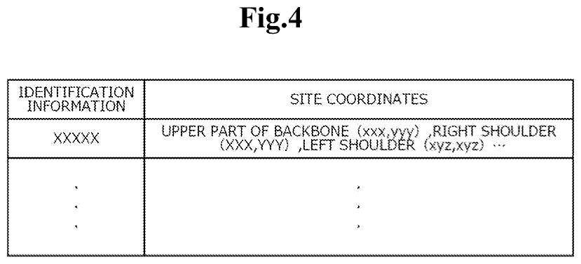

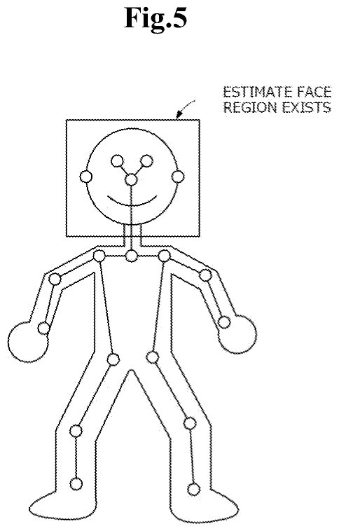

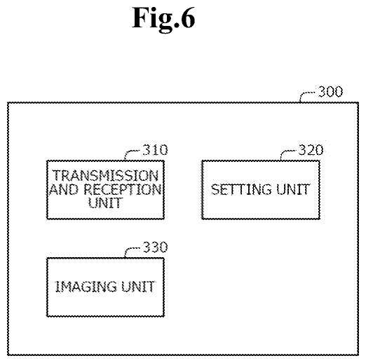

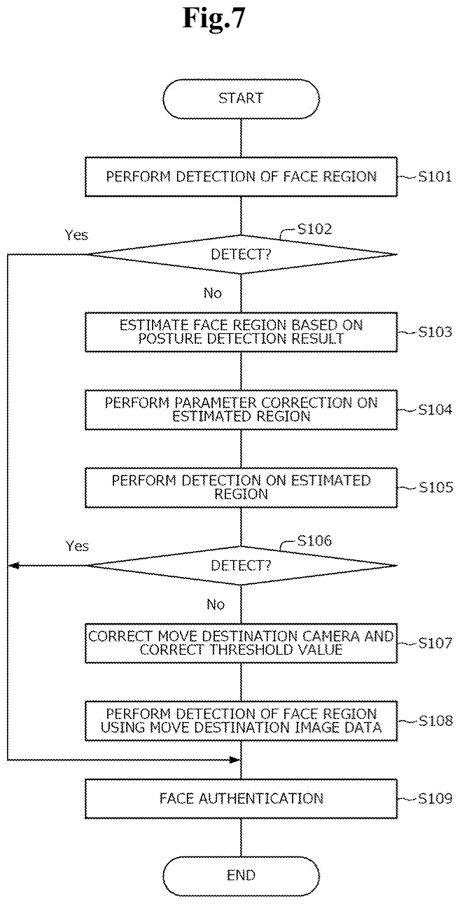

A first example embodiment of the present disclosure will be described with reference to FIGS. 1 to 7. FIG. 1 is a view showing an example of a configuration of a face authentication system 100. FIG. 2 is a block diagram showing an example of a configuration of a face authentication apparatus 200. FIG. 3 is a view showing an example of image information 234. FIG. 4 is a view showing an example of posture information 235. FIG. 5 is a view for describing processing by a face region estimation unit 244. FIG. 6 is a block diagram showing an example of a configuration of a camera 300. FIG. 7 is a flowchart showing an example of an operation of the face authentication apparatus 200.

In the first example embodiment of the present disclosure, the face authentication system 100 that detects a face region and performs face authentication will be described. As will be described later, in a case where the face authentication system 100 cannot detect the face region of an authentication target person based on image data acquired by a camera 300-1, the face authentication system 100 adjusts a parameter of an estimated region and the like based on the result of posture detection, and also reconfirms whether a face region is detected in the estimated region. In a case where a face region is not detected by the reconfirmation, the face authentication system 100 instructs a camera 300-2 that is a move destination camera to perform parameter adjustment, and adjusts a face detection threshold value used in detection of a face region. Then, the face authentication system 100 performs detection of a face region using the adjusted face detection threshold value based on image data acquired by the camera 300-2 after parameter adjustment. Thus, in a case where the face authentication system 100 cannot detect a face region based on image data acquired by the camera 300-1 that is a predetermined imaging device, the face authentication system 100 changes setting for performing a face region detection process based on image data acquired by the camera 300-2 that is another imaging device. The setting to be changed includes, for example, at least one of the parameter used when the camera 300 acquires image data and the face detection threshold value.

FIG. 1 shows an example of a configuration of the whole face authentication system 100. Referring to FIG. 1, the face authentication system 100 includes, for example, the face authentication apparatus 200 and two cameras 300 (the camera 300-1 and the camera 300-2, which will be described as the camera 300 when not particularly discriminated). As shown in FIG. 1, the face authentication apparatus 200 and the camera 300-1 are connected so as to be able to communicate with each other. Moreover, the face authentication apparatus 200 and the camera 300-2 are connected so as to be able to communicate with each other.

The face authentication system 100 is deployed in, for example, a shopping mall, an airport and a shopping street, and performs face authentication to search for a suspicious person, a lost child, and the like. A place to deploy the face authentication system 100 and a purpose that the face authentication system 100 performs face authentication may be other than those illustrated above.

The face authentication apparatus 200 is an information processing apparatus that performs face authentication based on image data acquired by the camera 300-1 and the camera 300-2. For example, in a case where the face authentication apparatus 200 cannot detect a face region based on image data acquired by the camera 300-1, the face authentication apparatus 200 performs detection of a face region based on image data acquired by the camera 300-2. FIG. 2 shows an example of a configuration of the face authentication apparatus 200. Referring to FIG. 2, the face authentication apparatus 200 includes, as major components, a screen display unit 210, a communication I/F unit 220, a storage unit 230, and an operation processing unit 240, for example.

The screen display unit 210 includes a screen display deice such as an LCD (Liquid Crystal Display). The screen display unit 210 displays, on a screen, information stored in the storage unit 230 such as authentication result information 236 in accordance with an instruction from the operation processing unit 240.

The communication I/F unit 220 includes a data communication circuit. The communication I/F unit 220 performs data communication with the camera 300 and an external device connected via a communication line.

The storage unit 230 is a storage device such as a hard disk and a memory. The storage unit 230 stores therein processing information necessary for various processing by the operation processing unit 240 and a program 237. The program 237 is loaded to and executed by the operation processing unit 240 to realize various processing units. The program 237 is loaded in advance from an external device or a recording medium via a data input/output function such as the communication I/F unit 220, and is stored in the storage unit 230. Major information stored in the storage unit 230 includes, for example, information for detection 231, a trained model 232, feature value information 233, the image information 234, posture information 235, and the authentication result information 236.

The information for detection 231 is information used when a face region detection unit 242 performs detection of a face region. As will be described later, the face region detection unit 242 may perform face detection by a generally-used face detection technique. Therefore, information included by the information for detection 231 may also be information corresponding to a method by which the face region detection unit 242 performs face detection. For example, the information for detection 231 may be a model trained based on luminance gradient information. The information for detection 231 is, for example, acquired in advance from an external device via the communication I/F unit 220 and stored in the storage unit 230.

The trained model 232 is a model having been trained, used when a posture detection unit 243 performs posture detection. The trained model 232 is, for example, generated in advance by learning using training data such as image data containing skeletal coordinates in an external device or the like, and is acquired from the external device or the like via the communication I/F unit 220 or the like and stored in the storage unit 230.

The feature value information 233 includes information indicating a face feature value used when a face authentication unit 246 performs face authentication. In the feature value information 233, for example, identification information for identifying a person and information indicating a face feature value are associated with each other. The feature value information 233 is, for example, acquired in advance from an external device or the like via the communication I/F unit 220 or the like, and is stored in the storage unit 230.

The image information 234 includes image data acquired by the camera 300. In the image information 234, for example, the image data and information indicating time and date of acquisition of the image data by the camera 300 are associated with each other.

FIG. 3 shows an example of the image information 234. As shown in FIG. 3, the image information 234 includes image data acquired from the camera 300-1 and image data acquired from the camera 300-2.

The posture information 235 includes information indicating a person's posture detected by the posture detection unit 243. For example, the posture information 235 includes information indicating the coordinates of each site of a person. FIG. 4 shows an example of the posture information 235. Referring to FIG. 4, in the posture information 235, identification information and site coordinates are associated with each other.

Sites included in the site coordinates correspond to those of the trained model 232. For example, FIG. 4 illustrates the upper part of the backbone, the right shoulder, the left shoulder, . . . . The site coordinates can include, for example, approximately 30 sites (may be other than those illustrated). The sites included in the site coordinates may be other than those illustrated in FIG. 4 and others.

The authentication result information 236 includes information indicating the result of authentication by the face authentication unit 246. The details of processing by the face authentication unit 246 will be described later.

The operation processing unit 240 has a microprocessor such as an MPU and a peripheral circuit thereof, and loads the program 237 from the storage unit 230 and executes the program 237 to make the abovementioned hardware and the program 237 cooperate and realize various processing units. The major processing units realized by the operation processing unit 240 are, for example, an image acquisition unit 241, the face region detection unit 242, the posture detection unit 243, the face region estimation unit 244, a parameter adjustment unit 245, the face authentication unit 246, and an output unit 247.

The image acquisition unit 241 acquires image data acquired by the camera 300 from the camera 300 via the communication IN unit 220. Then, the image acquisition unit 241 associates the acquired image data with, for example, the time and date of acquisition of the image data, and stores as the image information 234 into the storage unit 230.

In this example embodiment, the image acquisition unit 241 acquires image data from the camera 300-1, and also acquires image data from the camera 300-2. The image acquisition unit 241 may acquire image data from the camera 300-1 and the camera 300-2 at all times or, for example, may not acquire image data from the camera 300-2 until a predetermined condition is satisfied. For example, in a case where the face authentication apparatus 200 cannot detect a face region based on image data acquired by the camera 300-1, the face authentication apparatus 200 perform detection of a face region based on image data acquired by the camera 300-2. Therefore, the image acquisition unit 241 may be configured to, in a case where a face region cannot be detected based on image data acquired by the camera 300-1, acquire image data from the camera 300-2.

The face region detection unit 242 detects a face region of a person based on image data included by the image information 234. As described above, the face region detection unit 242 can detect a face region by a known technique. For example, the face region detection unit 242 performs detection of a face region using the information for detection 231 and a face detection threshold value. In other words, the face region detection unit 242 can detect a region where, for example, the degree of similarity to the information for detection 231 is equal to or more than the face detection threshold value, as a face region.

In this example embodiment, first, the face region detection unit 242 performs detection of a face region based on image data acquired from the camera 300-1 among image data included by the image information 234.

Further, in a case where a face region cannot be detected based on the image data acquired from the camera 300-1, the parameter adjustment unit 245 adjust a parameter of a region estimated based on the result of posture detection. After the abovementioned parameter adjustment, the face region detection unit 242 can confirm whether or not a face region exists in a region estimated by the face region estimation unit 244 based on the result of posture detection. In other words, the face region detection unit 242 can perform detection of a face region in a region estimated by the face region estimation unit 244 in a state that the parameter adjustment unit 245 has adjusted a parameter of a region estimated by the face region estimation unit 244.

Further, in a case where a face region is not detected even by reconfirmation (for example, in a case where a face region cannot be detected for a predetermined time period), the parameter adjustment unit 245 instructs the camera 300-2 to adjust a parameter, and the face detection threshold value is adjusted. For example, the parameter adjustment unit 245 lowers the face detection threshold value. The face region detection unit 242 can detect a face region using the adjusted face detection threshold value based on image data acquired by the camera 300-2 after the parameter adjustment. By performing face detection in a state that the face detection threshold value is lowered, a probability that face detection can be performed increases.

For example, as described above, the face region detection unit 242 can perform detection of a face region by various methods, such as detection of a face region based on image data acquired from the camera 300-1, detection of a face region based on image data acquired from the camera 300-1 and the camera 300-2 after parameter adjustment.

The posture detection unit 243 detects the posture of an authentication target person in image data by recognizing the skeleton of the person by using the trained model 232. For example, as shown in FIG. 4, the posture detection unit 243 recognizes sites such as the upper part of the backbone, the right shoulder, and the left shoulder. Moreover, the posture detection unit 243 calculates the coordinates in screen data of each of the recognized sites. Then, the posture detection unit 243 associates the recognition and calculation results with identification information, and stores as the posture information 235 into the storage unit 230.

The sites recognized by the posture detection unit 243 correspond to those of the trained model 232 (training data used for training the trained model 232). Therefore, the posture detection unit 243 may recognize a site other than the sites illustrated above in accordance with the trained model 232.

The face region estimation unit 244 estimates a region where a face region is estimated to exist based on the result of detection by the posture detection unit 243. For example, the face region estimation unit 244 estimates the region, for example, in a case where the face region detection unit 242 cannot detect a face region while the posture detection unit 243 detects a posture. The face region estimation unit 244 may estimate the region at a timing other than that illustrated above.

FIG. 5 is a view for describing an example of estimation by the face region estimation unit 244. As shown in FIG. 5, it can be estimated that a face region is located in the vicinity of the shoulders, neck and the like on the opposite side to a side where the hips, legs and others are located when viewed from a site such as the shoulders. Then, the face region estimation unit 244 can estimate a region where a face region is thought to exist by confirming the coordinates of each site with reference to the posture information 235.

The parameter adjustment unit 245 adjusts parameters used in the face authentication process, such as a parameter used when the camera 300 acquires image data and a face detection threshold value.

For example, in a case where the face region detection unit 242 cannot detect a face region based on image data acquired from the camera 300-1, the parameter adjustment unit 245 performs parameter adjustment on a region estimated by the face region estimation unit 244. Specifically, for example, the parameter adjustment unit 245 instructs the camera 300-1 to performs adjustment of parameters used when the camera 300-1 acquires image data on a region estimated by the face region estimation unit 244. Consequently, the camera 300-1 corrects the parameters and acquires image data by using the corrected parameters.

The parameter adjustment unit 245 may instruct the camera 300-1 to perform parameter correction on the entire image data. Moreover, together with the instruction to the camera 300-1 described above, the parameter adjustment unit 245 may perform adjustment of parameters used when the face region detection unit 242 detects a face region, for example, lower the face detection threshold value.

Further, in a case where the face region detection unit 242 cannot detect a face region even by reconfirmation, the parameter adjustment unit 245 instructs the camera 300-2 to adjust parameters used in acquisition of image data. When the parameter adjustment unit 245 instructs the camera 300-2 to adjust parameters based on the result of detection of a face region based on image data acquired by the camera 300-1, it is thereby possible to adjust the parameters in advance, for example, before an authentication target person is caught in image data acquired by the camera 300-2. Moreover, the parameter adjustment unit 245 can adjust the parameters used when the face region detection unit 242 detects a face region, for example, lower the face detection threshold value.

For example, as described above, the parameter adjustment unit 245 adjusts parameters used in face authentication based on the result of detection by the face region detection unit 242.

The parameters that the parameter adjustment unit 245 instructs the camera 300 to adjust include, for example, brightness, sharpness, contrast and the like, and a frame rate indicating the number of image data acquisitions per unit time. For example, in a case where it is assumed that face detection has failed because the brightness value is too high due to backlight, the parameter adjustment unit 245 instructs to lower the brightness. The parameters adjusted by the parameter adjustment unit 245 may be at least some of those illustrated above, or may be other than those illustrated above.

Further, the parameter adjustment unit 245 can instruct the camera 300-1 and the camera 300-2 to perform parameter adjustment and also instruct the time for performing parameter adjustment. For example, it is possible to calculate in advance a time from when an authentication target person is caught in image data acquired by the camera 300-1 to when the authentication target person is caught in image data acquired by the camera 300-2, based on information indicating the installation positions of the camera 300-1 and the camera 300-2 and information indicating a walking speed. Then, the parameter adjustment unit 245 may instruct the camera 300-2 to perform parameter adjustment during a time that the authentication target person is estimated to be caught by the camera 300-2. The time to instruct the camera 300-2 to perform parameter adjustment may be estimated in advance, for example, by using a normal walking speed, or may be calculated based on the walking speed of the person calculated based on the image data acquired by the camera 300-1.

The face authentication unit 246 performs face authentication by using the result of detection by the face region detection unit 242. Then, the face authentication unit 246 stores the result of the face authentication as the authentication result information 236 into the storage unit 230.

For example, the face authentication unit 246 extracts feature points such as the eyes, nose and mouth of a person in the face region detected by the face region detection unit 242, and calculates a feature value based on the extracted result. Then, for example, by confirming whether or not the degree of similarity between the calculated feature value and the face feature value included in the feature value information 233 exceeds a face comparison threshold value, the face authentication unit 246 performs matching between the calculated feature value and the feature value stored in the storage unit 230, and performs authentication based on the result of matching. By performing face authentication in this manner, the face authentication unit 246 can identify an identification target person such as a lost child.

The output unit 247 outputs the authentication result information 236 indicating the result of the authentication process by the face authentication unit 246. The output by the output unit 247 is, for example, displaying on a screen of the screen display unit 210, or transmitting to an external device via the communication IN unit 220.

The above is an example of a configuration of the face authentication apparatus 200.

The camera 300 is an imaging device that acquires image data, for example, a surveillance camera. FIG. 6 shows an example of a configuration of the camera 300. Referring to FIG. 6, the camera 300 includes, for example, a transmission and reception unit 310, a setting unit 320, and an imaging unit 330.

For example, the camera 300 includes an arithmetic logic unit such as a CPU and a storage unit. The camera 300 can realize the abovementioned processing units by execution of a program stored in the storage unit by the arithmetic logic unit.

The transmission and reception unit 310 transits and receives data to and from the face authentication apparatus 200 and the like. For example, the transmission and reception unit 310 transmits image data acquired by the imaging unit 330 to the face authentication apparatus 200. Moreover, the transmission and reception unit 310 receives a parameter adjustment instruction and the like from the face authentication apparatus 200.

The setting unit 320 adjusts a parameter used when the imaging unit 330 acquires image data based on a parameter adjustment instruction received from the face authentication apparatus 200. For example, the setting unit 320 adjusts brightness, sharpness, contrast, frame rate, and the like, based on an instruction received from the face authentication apparatus 200. The setting unit 320 can perform parameter adjustment on a designated region in accordance with an instruction.

The imaging unit 330 acquires image data by using a parameter set by the setting unit 320. Image data acquired by the imaging unit 330 can be associated with time and date of acquisition of image data by the imaging unit 330, and the like, and transmitted to the face authentication apparatus 200 via the transmission and reception unit 310.

The above is an example of a configuration of the camera 300. Subsequently, an example of an operation of the face authentication apparatus 200 will be described with reference to FIG. 7.

Referring to FIG. 7, the face region detection unit 242 performs detection of a face region based on image data acquired from the camera 300-1 among image data included by the image information 234 (step S101).

In a case where a face region cannot be detected, for example, for a predetermined time period (step S102, No), the face region estimation unit 244 estimates a region where a face region is estimated to exist based on the result of detection by the posture detection unit 243 (step S103). Moreover, the parameter adjustment unit 245 instructs the camera 300-1 to perform adjustment of a parameter used when the camera 300-1 acquires image data on the region estimated by the face region estimation unit 244 (step S104). Then, the camera 300-1 corrects the parameter.

The face region detection unit 242 performs detection of a face region on the region estimated by the face region estimation unit 244 (step S105).

In a case where a face region cannot be detected, for example, for a predetermined time period (step S106, No), the parameter adjustment unit 245 instructs the camera 300-2 to adjust a parameter used in acquisition of image data. Moreover, the parameter adjustment unit 245 adjusts a parameter used when the face region detection unit 242 performs detection of a face region, for example, lowers a face detection threshold value (step S107).

The face region detection unit 242 performs detection of a face region using the adjusted face detection threshold value based on image data acquired by the camera 300-2 after the parameter adjustment (step S108).

When the face region detection unit 242 detects a face region, the face authentication unit 246 performs face authentication using the result of detection by the face region detection unit 242 (step S109).

The above is an example of the operation of the face authentication apparatus 200.

Thus, the face authentication apparatus 200 includes the face region detection unit 242 and the parameter adjustment unit 245. With such a configuration, the parameter adjustment unit 245 can instruct the camera 300-2 to adjust a parameter based on the result of detection of a face region based on image data acquired by the camera 300-1. Moreover, the parameter adjustment unit 245 can lower a face detection threshold value in advance. As a result, the face region detection unit 242 can perform detection of a face region based on image data acquired in a state that a parameter is adjusted in advance. Consequently, it becomes possible to appropriately adjust a parameter and inhibit failure to detect a face region.

Further, with the above configuration, for example, it becomes possible to increase the frame rate of the camera 300-2 only at a timing when detection of a face region based on image data acquired by the camera 300-2 is required. As a result, it is possible to inhibit unnecessarily increasing data traffic, and it becomes possible to realize efficient processing.

Further, the face authentication apparatus 200 includes the posture detection unit 243 and the face region estimation unit 244. With such a configuration, the face region estimation unit 244 can estimate a region where a face region is estimated to exist, based on the result of detection by the posture detection unit 243. As a result, for example, it becomes possible to narrow down the range of parameter adjustment by the parameter adjustment unit 245 and the range of detection of a face region by the face region detection unit 242, and it becomes possible to realize efficient parameter adjustment and face region detection.

In this example embodiment, the parameter adjustment unit 245 instructs the camera 300-2 to adjust a parameter used in acquisition of image data when the face region detection unit 242 cannot detect a face region even by reconfirmation. However, the parameter adjustment unit 245 may be configured to, when a face region cannot be detected based on image data acquired from the camera 300-1, instruct the camera 300-2 to perform parameter correction without reconfirmation. In this case, for example, the processes from steps S103 to S105 described with reference to FIG. 7 may be omitted. Moreover, in a case where the processes from steps S103 to S105 are not performed, the face authentication apparatus 200 may not have the posture detection unit 243 and the face region estimation unit 244. For example, as described above, the face authentication apparatus 200 may have only part of the configuration illustrated in FIG. 2

Further, FIG. 2 illustrates a case of realizing the function as the face authentication apparatus 200 by using one information processing apparatus. However, the function as the face authentication apparatus 200 may be realized by, for example, a plurality of information processing apparatuses connected via a network.

### Second Example Embodiment

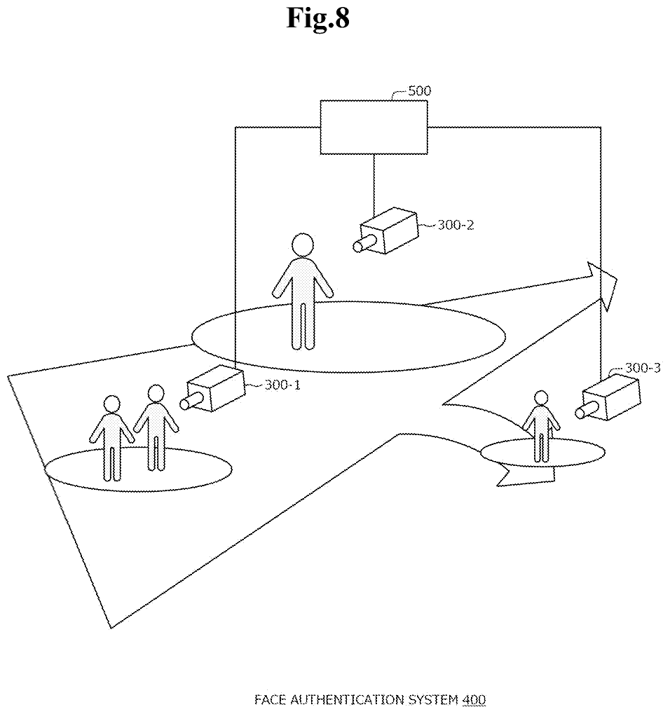

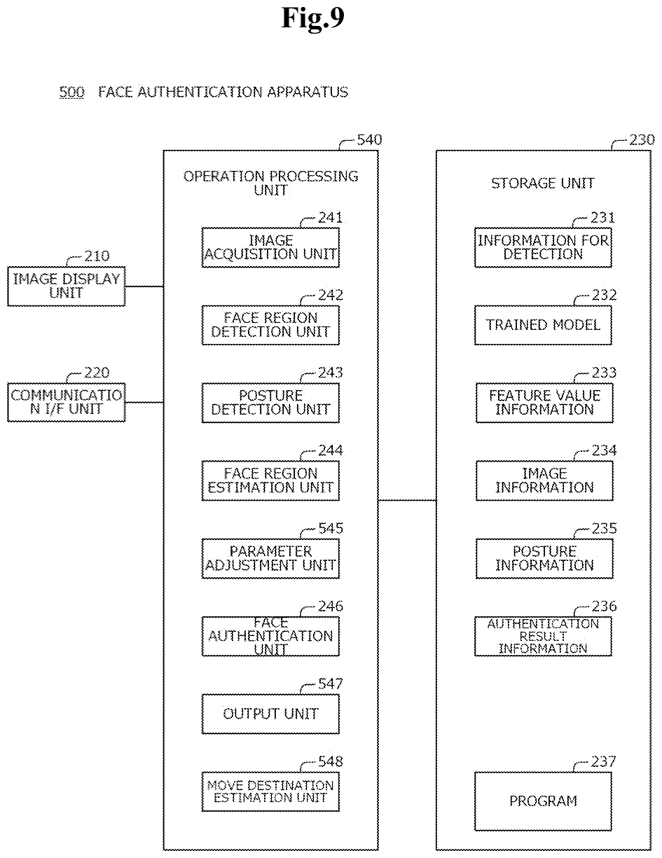

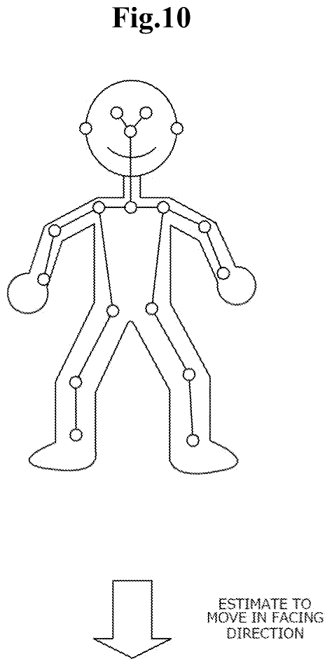

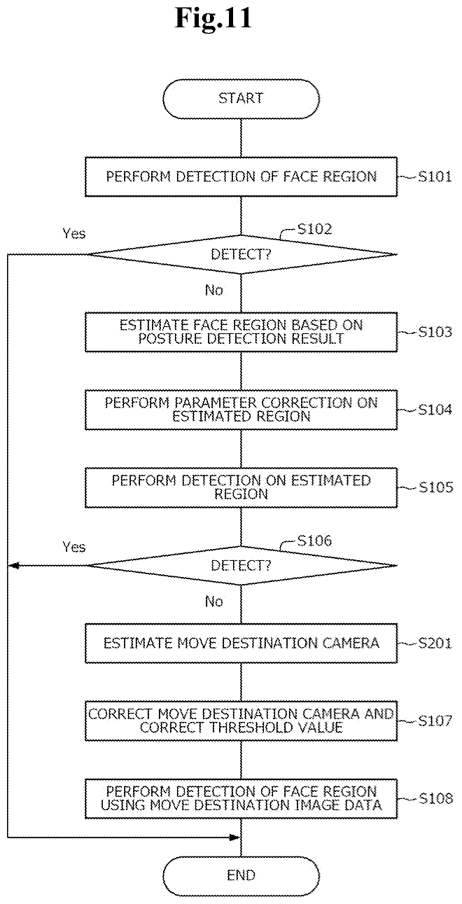

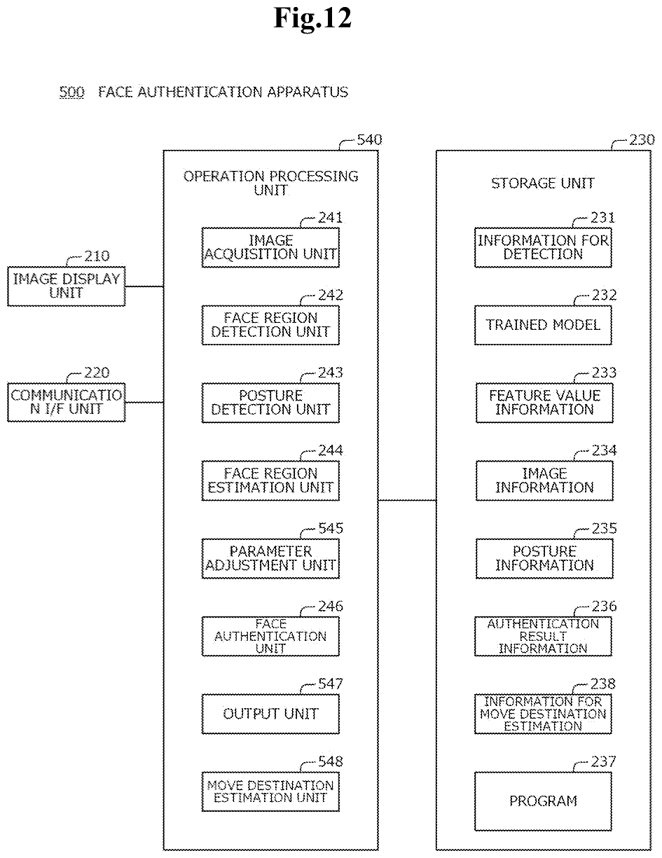

Next, a second example embodiment of the present disclosure will be described with reference to FIGS. 8 to 12. FIG. 8 is a view showing an example of a configuration of a face authentication system 400. FIG. 9 is a block diagram showing an example of a configuration of a face authentication apparatus 500. FIG. 10 is a view for describing an example of processing by a move destination estimation unit 548. FIG. 11 is a flowchart showing an example of an operation of the face authentication apparatus 500. FIG. 12 is a block diagram showing another example of the configuration of the face authentication apparatus 500.

In the second example embodiment of the present disclosure, the face authentication system 500, which is a modified example of the face authentication system 100 described in the first example embodiment, will be described. In the first example embodiment, the face authentication system 100 including two cameras 300, that is, the camera 300-1 and the camera 300-2 has been described. In this example embodiment, the face authentication system 400 including three or more cameras 300 will be described. As will be described later, when the face authentication system 400 cannot detect a face region based image data acquired by the camera 300-1, the face authentication system 400 estimates a camera to be a move destination based on the result of posture detection. Then, the face authentication system 400 instructs the estimated camera 300 to perform parameter adjustment.

FIG. 8 shows an example of a configuration of the whole face authentication system 400. Referring to FIG. 8, the face authentication system 400 includes the face authentication apparatus 500 and three cameras 300 (camera 300-1, camera 300-2, camera 300-3). As shown in FIG. 8, the face authentication apparatus 500 and the camera 300-1 are connected so as to be able to communicate with each other. The face authentication apparatus 500 and the camera 300-2 are connected so as to be able to communicate with each other. The face authentication apparatus 500 and the camera 300-3 are connected so as to be able to communicate with each other.

FIG. 8 illustrates a case where the face authentication system 400 includes three cameras 300. However, the number of the cameras 300 included by the face authentication system 400 is not limited to three. The face authentication system 400 may include four or more cameras 300.

The face authentication apparatus 500, as well as the face authentication apparatus 200 described in the first example embodiment, is an information processing apparatus that performs face authentication. FIG. 9 shows an example of a configuration of the face authentication apparatus 500. Referring to FIG. 9, the face authentication apparatus 500 includes, as major components, a screen display unit 210, a communication I/F unit 220, a storage unit 230, and an operation processing unit 540, for example. Below, a configuration which is characteristic of this example embodiment will be described.

The operation processing unit 540 includes a microprocessor such as an MPU and a peripheral circuit thereof, and retrieves the program 237 from the storage unit 230 and executes the program 237 to make the abovementioned hardware and the program 237 cooperate and realize various processing units. Major processing units realized by the operation processing unit 540 are, for example, the image acquisition unit 241, the face region detection unit 242, the posturer detection unit 243, the face region estimation unit 244, a parameter adjustment unit 545, the face authentication unit 246, an output unit 546, and a move destination estimation unit 548.

The move destination estimation unit 548 estimates the camera 300 located in the move destination of a person whose face region cannot be detected, based on the result of detection by the posture detection unit 243. For example, in a case where the face region detection unit 242 cannot detect a face region even by reconfirmation, the move destination estimation unit 548 refers to the posture information 235, and acquires information indicating the installation position of the camera 300. Then, the move destination estimation unit 548 estimates the camera 300 located in the move destination of the person based on the posture information 235 and the information indicating the installation position of the camera 300.

FIG. 10 is a view for describing an example of estimation by the move destination estimation unit 548. As shown in FIG. 10, the body of a person is generally oriented in the moving direction. Therefore, it can be estimated that a direction in which the body of a person to be determined based on the posture information 235 faces is the moving direction of the person. The move destination estimation unit 548 estimates that the camera 300 located ahead of the estimated movement direction of the person is the camera 300 located at the move destination of the person, based on the posture information 235 and the information indicating the installation position of the camera 300.

The move destination estimation unit 548 may be configured to extract the movement locus of a person based on image data of a plurality of frames and estimate the camera 300 whether the camera 300 is located at the move destination based on the extracted movement locus. The move destination estimation unit 548 may perform estimation by combining estimation based on the result of detection by the posture detection unit 243 and estimation based on the movement locus, for example.

The parameter adjustment unit 545 adjusts parameters used in the face authentication process, such as a parameter used when the camera 300 acquires image data and a face detection threshold value.

For example, when the face region detection unit 242 cannot detect a face region based on image data acquired from the camera 300-1, the parameter adjustment unit 545 performs parameter adjustment on a region estimated by the face region estimation unit 244. Specifically, for example, the parameter adjustment unit 245 instructs the camera 300-1 to perform adjustment of a parameter used when the camera 300-1 acquires image data on a region estimated by the face region estimation unit 244. Then, the camera 300-1 corrects the parameter and acquires image data using the corrected parameter.

Further, in a case where the face region detection unit 242 cannot detect a face region even by reconfirmation, the parameter adjustment unit 545 instructs the camera 300 estimated by the move destination estimation unit 548 to adjust a parameter used in acquisition of image data. Moreover, the parameter adjustment unit 545 can adjust a parameter used when the face region detection unit 242 detects a face region, for example, lower the face detection threshold value.

For example, as described above, when adjusting the parameter of the move destination camera 300, the parameter adjustment unit 545 instructs the camera 300 estimated by the move destination estimation unit 548 to perform parameter adjustment.

The output unit 547 outputs the authentication result information 236 indicating the result of the authentication process by the face authentication unit 246. The output by the output unit 547 is, for example, displaying on a screen of the screen display unit 210, or transmitting to an external device via the communication I/F unit 220.

Further, the output unit 547 can output information of an identification target person identified by authentication by the face authentication unit 246, and the like, and also output information indicating a moving direction of the person estimated by the move destination estimation unit 548, and the like. By outputting the information indicating the moving direction together with the information of the identification target person having been identified, a person who receives the output by the output unit 547 can know the moving direction of the identification target, and can find the identification target person more rapidly.

The above is a description of the configuration that is characteristic of this example embodiment in the configuration of the face authentication apparatus 500. Subsequently, an example of an operation of the face authentication apparatus 500 will be described with reference to FIG. 11. Hereinafter, an operation that is characteristic of this example embodiment in the operation of the face authentication apparatus 500 will be described.

The processes up to step S105 are the same as in the operation of the face authentication apparatus 200 described in the first example embodiment. In a case where a face region cannot be detected, for example, for a predetermined time period after the process at step S105 (step S106, No), the move destination estimation unit 548 estimates the camera 300 located at the move destination of the person (step S201).

The parameter adjustment unit 545 instructs the camera 300 estimated by the move destination estimation unit 548 to adjust a parameter used in acquisition of image data. Moreover, the parameter adjustment unit 245 adjusts a parameter used when the face region detection unit 242 performs detection of a face region, for example, lowers a face detection threshold value (step S107). The subsequent processes are the same as in the operation of the face authentication apparatus 200 described in the first example embodiment.

The above is an operation that is characteristic of this example embodiment in the example of the operation of the face authentication apparatus 500.

Thus, the face authentication apparatus 500 includes the move destination estimation unit 548 and the parameter adjustment unit 245. With such a configuration, the parameter adjustment unit 245 can instruct the camera 300 estimated by the move destination estimation unit 548 to adjust a parameter used in acquisition of image data. As a result, it becomes possible to adjust only the parameter of the required camera 300 in advance, and it becomes possible to more exactly adjust even when three or more cameras 300 are provided. Moreover, since it is possible to inhibit increase of the frame rate of the camera 300 that is not the move destination, it is possible to inhibit a situation in which data traffic is unnecessarily increased, for example.

The move destination estimation unit 548 may use information for move destination estimation 238 stored in the storage unit 230 as shown in FIG. 12 when estimating the camera 300 located at the move destination. The information for move destination estimation 238 can include, other than information indicating the position of the camera 300, for example, information indicating the movement tendency of persons for each time of day such that many people heads in this direction in the morning time, information indicating the movement tendency for each person's attribute such as clothes, belongings, gender and age. The information for move destination estimation 238 may include information other than the information used in estimation of the move destination illustrated above.

Further, the face authentication system 400 and the face authentication apparatus 500 can be modified in various manners as described in the first example embodiment.

### Third Example Embodiment

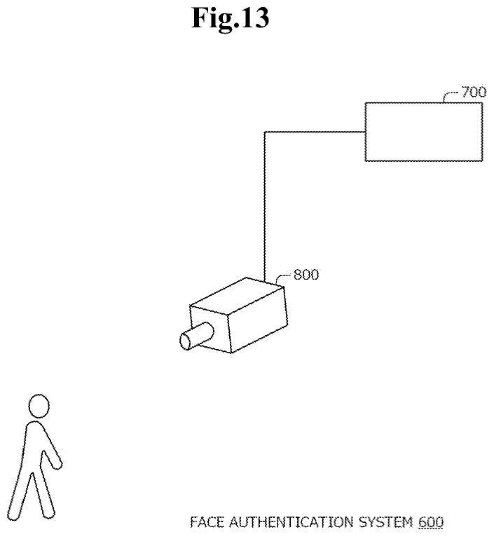

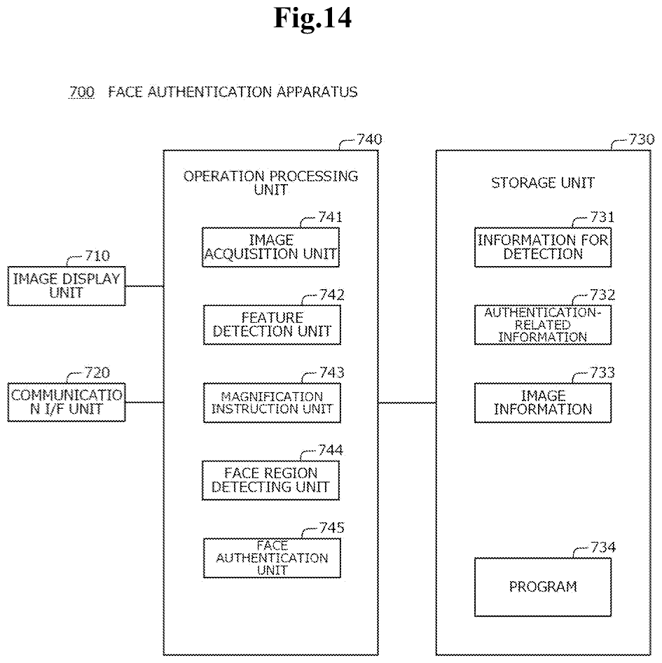

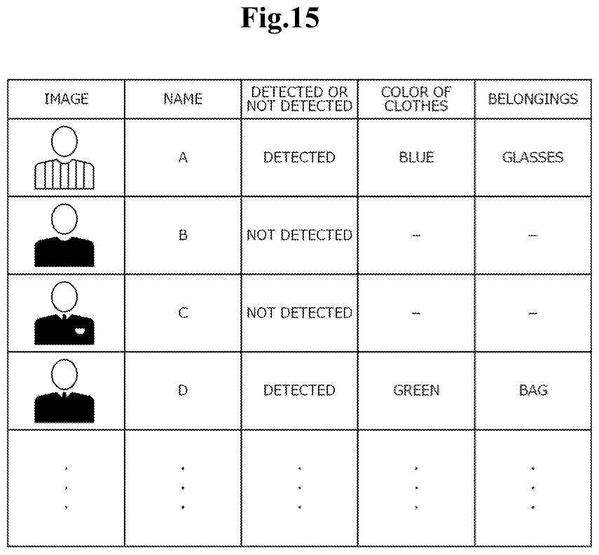

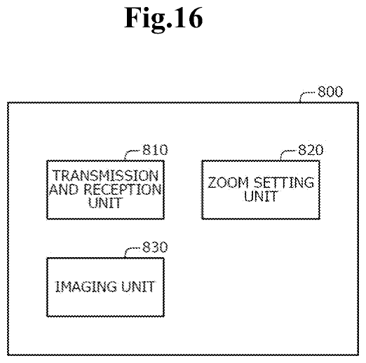

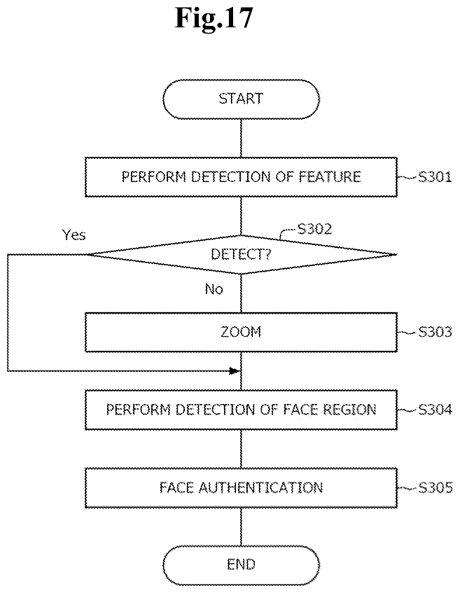

Next, a third example embodiment of the present disclosure will be described with reference to FIGS. 13 to 17. FIG. 13 is a view showing an example of a configuration of a face authentication system 600. FIG. 14 is a block diagram showing an example of a configuration of a face authentication apparatus 700. FIG. 15 is a view showing an example of authentication-related information 732. FIG. 16 is a block diagram showing an example of a configuration of a camera 800. FIG. 17 is a flowchart showing an example of an operation of the face authentication apparatus 700.

In the third example embodiment of the present disclosure, the face authentication system 600 that detects a face region and performs face authentication will be described. As will be described later, the face authentication system 600 manages person-related information such as the color of clothes and belongings of a person whose face has been authenticated. Moreover, when it is determined that a person having an unauthenticated feature is caught in image data based on the person-related information, the face authentication system 600 instructs the camera 800 to magnify the face of the person by optical zoom, digital zoom, or the like, on the person.

FIG. 13 shows an example of a configuration of the whole face authentication system 600. Referring to FIG. 13, the face authentication system 600 includes the face authentication apparatus 700 and the camera 800. As shown in FIG. 13, the face authentication apparatus 700 and the camera 800 are connected so as to be able to communicate with each other.

FIG. 13 illustrates a case where the face authentication system 600 includes one camera 800. However, the number of the cameras 800 included by the face authentication system 600 is not limited to one. The face authentication system 600 may include two or more cameras 800. Moreover, in a case where the face authentication system 600 includes two or more cameras 800, the face authentication apparatus 700 may have a function as the face authentication apparatus 200 described in the first example embodiment or the face authentication apparatus 500 described in the second example embodiment.

The face authentication apparatus 700 is an information processing apparatus that performs face authentication based on image data acquired by the camera 800. For example, in a case where the face authentication apparatus 700 determines that a person having an unauthenticated feature is caught in image data based on the person-related information managed thereby, the face authentication apparatus 700 instructs the camera 800 to magnify the person and the face of the person by optical zoom, digital zoom, or the like, on the person. Then, the face authentication apparatus 700 performs detection of a face region and performs face authentication based on the image data in which the person is magnified. FIG. 14 shows an example of a configuration of the face authentication apparatus 700. Referring to FIG. 14, the face authentication apparatus 700 includes, as major components, a screen display unit 710, a communication I/F unit 720, a storage unit 730, and an operation processing unit 740, for example.

The configurations of the screen display unit 710 and the communication I/F unit 720 may be the same as those of the screen display unit 210 and the communication I/F unit 220 described in the first and second example embodiments. Therefore, a description thereof will be omitted.

The storage unit 730 is a storage device such as a hard disk and a memory. The storage unit 730 stores therein processing information necessary for various processing in the operation processing unit 740 and a program 734. The program 734 is loaded to and executed by the operation processing unit 740 to realize various processing units. The program 734 is retrieved in advance from an external device or a recording medium via a data input/output function such as the communication I/F unit 720 and is stored in the storage unit 730. Major information stored in the storage unit 730 are, for example, information for detection 731, authentication-related information 732, and image information 733.

The information for detection 731 may be the same as the information for detection 231 described in the first and second example embodiments. Therefore, a description thereof will be omitted.

The authentication-related information 732 includes information indicating a face feature value used when the face authentication unit 745 performs face authentication. Moreover, the authentication-related information 732 includes information indicating whether or not authentication has been performed, person-related information such as the color of clothes and belongings of a person, and the like.

FIG. 15 shows an example of the authentication-related information 732. Referring to FIG. 15, in the authentication-related information 732, for example, information indicating the feature value of a person, identification information such as name, the presence or absence of detection indicating whether or not authentication has been performed, the color of clothes, and belongings are associated with each other. The authentication-related information 732 may include person-related information other than the color of clothes and the belongings.

The image information 733 includes image data acquired by the camera 800. In the image information 733, for example, the image data, information indicating time and date of acquisition of the image data by the camera 800, and the like, are associated with each other. As described above, the camera 800 may acquire image data in which a person or a face is magnified in accordance with an instruction from the face authentication apparatus 700. Therefore, the image information 733 includes image data in which a person or a face is magnified.

The operation processing unit 740 includes a microprocessor such as an MPU and a peripheral circuit, and retrieves the program 734 from the storage unit 730 and executes the program 734 to make the above hardware and the programs cooperate with each other and realize various processing units. Major processing units realized by the operation processing unit 740 are, for example, an image acquisition unit 741, a feature detection unit 742, a magnification instruction unit 743, a face region detection unit 744, and a face authentication unit 74.

The image acquisition unit 741 acquires image data acquired by the camera 800 from the camera 800 via the communication I/F unit 720. Then, the image acquisition unit 741 associates the acquired image data with, for example, time and date of acquisition of the image data and stores as the image information 733 into the storage unit 730.

The feature detection unit 742 detects person-related information, which is information to be a feature of a person such as the color of clothes of the person and the belongings of the person, based on image data included by the image information 733. The feature detection unit 742 may detect information indicating the color of clothes of the person and the belongings of the person by a known technique. For example, in a case where the face authentication apparatus 700 has a function of a posture detection unit or the like (the posture detection unit 243 described in the first example embodiment), the feature detection unit 742 may detect the color of the clothes and the belonging of a person by using the result of detection by the posture detection unit.

The magnification instruction unit 743 confirms whether or not the person-related information detected by the feature detection unit 742 is stored as authenticated in the authentication-related information 732. Then, in a case where the person-related information detected by the feature detection unit 742 is not stored as authenticated in the authentication-related information 732, the magnification instruction unit 743 instructs the camera 800 to magnify the person having the unstored feature. For example, the magnification instruction unit 743 may instruct to magnify the person and the periphery thereof, or may instruct to magnify the person's face and the periphery thereof.

The face region detection unit 744 detects a face region of a person based on image data included by the image information 733. As well as the face region detection unit 242, the face region detection unit 744 can detect a face region by a known technique.

As described above, the image information 733 includes image data in which a person or a face is magnified. Therefore, the face region detection unit 744 can detect the face region of the person based on the image data in which the person or the face is magnified.

The face authentication unit 745 performs face authentication using the result of detection by the face region detection unit 744. Then, the face authentication unit 745 associates the face authentication result with person-related information of the authenticated person, and stores as the authentication-related information 732 into the storage unit 730.

Processing in performing the face authentication by the face authentication unit 745 may be the same as that of the face authentication unit 246 described in the first and second example embodiments. Therefore, a description thereof will be omitted.

The above is an example of the configuration of the face authentication apparatus 700.

The camera 800 is an imaging device that acquires image data. FIG. 16 shows an example of a configuration of the camera 800. Referring to FIG. 16, the camera 800 includes, for example, a transmission and reception unit 810, a zoom setting unit 820, and an imaging unit 830.

For example, the camera 800 includes an arithmetic logic unit such as a CPU and a storage unit. The camera 800 can realize the above processing units by execution of a program stored in the storage unit by the arithmetic logic unit.

The transmission and reception unit 810 transmits and receives data to and from the face authentication apparatus 700. For example, the transmission and reception 810 transmits image data acquired by the imaging unit 830 to the face authentication apparatus 700. Moreover, the transmission and reception unit 810 receives a zoom instruction from the face authentication apparatus 700.

The zoom setting unit 820 magnifies a designated person or face based on a zoom instruction received from the face authentication apparatus 700. The zoom setting unit 820 may perform optical zoom or perform digital zoom based on the zoom instruction.

The imaging unit 830 acquires image data. In a case where the zoom setting unit 820 has accepted a zoom instruction, the imaging unit 830 acquires image data in which a person or a face is magnified. The image data acquired by the imaging unit 830 can be associated with time and date when the imaging unit 830 acquires the image data, and transmitted to the face authentication apparatus 700 via the transmission and reception unit 810.

The above is an example of the configuration of the camera 800. Subsequently, an example of an operation of the face authentication apparatus 700 will be described with reference to FIG. 17.

Referring to FIG. 17, the feature detection unit 742 detects person-related information, which is information to be a feature of a person such as the color of clothes of the person and the belongings of the person, based on image data included by the image information 733 (step S301).

The magnification instruction unit 743 confirms whether or not the person-related information detected by the feature detection unit 742 is stored as authenticated in the authentication-related information 732 (step S302).

In a case where the person-related information detected by the feature detection unit 742 is not stored as authenticated in the authentication-related information 732 (step S303), the magnification instruction unit 743 instructs the camera 800 to magnify the person having the unstored feature (step S303). For example, the magnification instruction unit 743 may instruct to magnify the person and the periphery thereof, or may instruct to magnify the person's face and the periphery thereof.

The face region detection unit 744 detects a face region of the person based on the image data included by the image information 733 (step S304). Since the magnification instruction unit 743 has instructed to zoom by the process at step S303, the face region detection unit 744 can detect the face region of the person based on the image data in which the person or the face is magnified.

The face authentication unit 745 performs face authentication using the result of detection by the face region detection unit 744 (step S305). Then, the face authentication unit 745 associates the result of face authentication with the person-related information of the authenticated person, and stores as the authentication-related information 732 into the storage unit 730.

The above is an example of the operation of the face authentication apparatus 700.

Thus, the face authentication apparatus 700 includes the feature detection unit 742, the magnification instruction unit 743, and the face region detection unit 744. With such a configuration, the magnification instruction unit 743 can instruct the camera 800 to magnify a person or a face based on the result of detection by the feature detection unit 742. As a result, the face region detection unit 744 can perform detection of a face region by using image data in which the person or the face is magnified. Consequently, it becomes possible to perform detection of a face region more accurately.

As described above, the face authentication system 600 can include a plurality of cameras 800. Moreover, the face authentication apparatus 700 can include a function of the face authentication apparatus 200 described in the first example embodiment and the face authentication apparatus 500 described in the second example embodiment. The face authentication system 600 and the face authentication apparatus 700 may have the same modified examples as in the first example embodiment and the second example embodiment.

### Fourth Example Embodiment

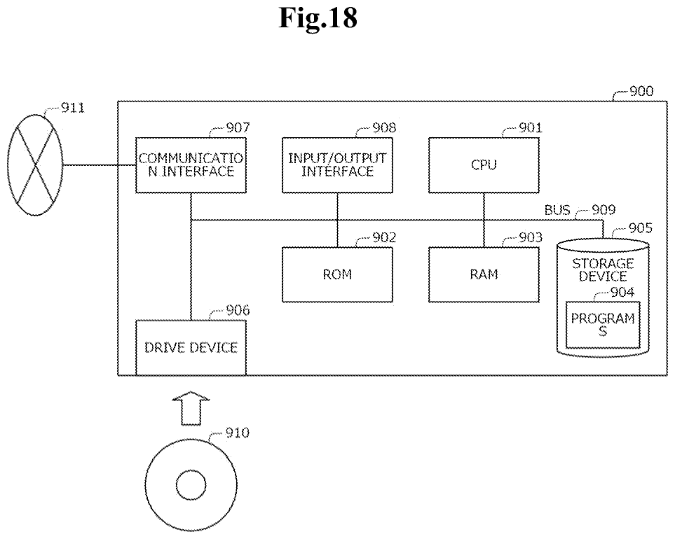

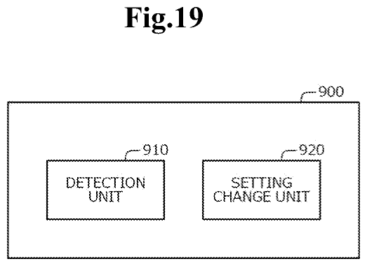

Next, a fourth example embodiment of the present invention will be described with reference to FIGS. 18 and 19. FIGS. 18 and 19 show an example of a configuration of a detection apparatus 900

The detection apparatus 900 detects a face region of a person based on image data. FIG. 18 shows an example of a hardware configuration of the detection apparatus 900. Referring to FIG. 18, the detection apparatus 900 has, as an example, the following hardware configuration including;

a CPU (Central Processing Unit) 901 (arithmetic logic unit),

a ROM (Read Only Memory) 902 (storage unit),

a RAM (Random Access Memory) 903 (storage unit),

programs 904 loaded to the RAM 903,

a storage device 905 for storing the programs 904,

a drive device 906 that reads from and writes into a recording medium 910 outside the information processing apparatus,

a communication interface 907 connecting to a communication network 911 outside the information processing apparatus,

an input/output interface 908 that inputs and outputs data, and

a bus 909 connecting the respective components.

Further, the detection apparatus 900 can realize functions as a detection unit 921 and a setting change unit 922 shown in FIG. 30 by acquisition and execution of the programs 904 by the CPU 901. The programs 904 are, for example, stored in the storage device 905 or the ROM 902 in advance, and are loaded to the RAM 903 or the like by the CPU 901 as necessary. Moreover, the programs 904 may be supplied to the CPU 901 via the communication network 911, or may be stored in the recording medium 910 in advance and retrieved and supplied to the CPU 901 by the drive device 906.

FIG. 18 shows an example of the hardware configuration of the detection apparatus 900. The hardware configuration of the detection apparatus 900 is not limited to the abovementioned case. For example, the detection apparatus 900 may be configured by part of the abovementioned configuration, for example, excluding the drive device 906.

The detection unit 921 performs detection of a face region based on image data acquired by a predetermined imaging device.

The setting change unit 922 changes the setting for performing a face region detection process with image data acquired by another imaging device, based on the result of detection by the detection unit 921.

Thus, the detection apparatus 900 includes the detection unit 921 and the setting change unit 922. With such a configuration, the setting change unit 922 can change the setting for performing a face region detection process with image data acquired by another imaging device, based on the result of detection by the detection unit 921. As a result, it becomes possible to properly perform parameter adjustment and inhibit failure to detect a face region.

The above detection apparatus 900 can be realized by installation of a predetermined program into the detection apparatus 900. Specifically, a program as another aspect of the present invention is a program for causing the detection apparatus 900 performing detection of a face region based on image data to realize: the detection unit 921 performing detection of a face region based on image data acquired by a predetermined imaging device; and the setting change unit 922 changing the setting for performing a face region detection process with image data acquired by another imaging device, based on the result of detection by the detection unit 921.

Further, a detection method executed by the above detection apparatus 900 is a method including, by the detection apparatus 900 performing detection of a face region based on image data: performing detection of a face region based on image data acquired by a predetermined imaging device; and changing the setting for performing a face region detection process with image data acquired by another imaging device, based on the detection result.

A program (a recording medium on which a program is recorded) or a detection method having the above configuration also has the same action and effect as the above detection apparatus 900, and therefore, can achieve the abovementioned object of the present invention.

### <Supplementary Notes>

The whole or part of the example embodiments disclosed above can be described as the following supplementary notes. Below, the overview of a detection method and others according to the present invention will be described. However, the present invention is not limited to the following configurations.

### (Supplementary Note 1)

A detection method executed by a detection apparatus, the detection method comprising:

performing detection of a face region based on image data acquired by a predetermined imaging device; and

changing setting for performing a face region detection process with image data acquired by another imaging device, based on a result of the detection.

### (Supplementary Note 2)

The detection method according to Supplementary Note 1, comprising

instructing the other imaging device to adjust a parameter used when the other imaging device acquires image data, based on the result of the detection.

### (Supplementary Note 3)

The detection method according to Supplementary Note 1 or 2, comprising

adjusting a face detection threshold value used for performing the face region detection process with the image data acquired by the other imaging device, based on the result of the detection.

### (Supplementary Note 4)

The detection method according to any one of Supplementary Notes 1 to 3, comprising

in a case where a face region cannot be detected based on the image data acquired by the predetermined imaging device, changing the setting for performing the face region detection process with the image data acquired by the other imaging device.

### (Supplementary Note 5)

The detection method according to any one of Supplementary Notes 1 to 4, comprising

in a case where a face region cannot be detected based on the image data acquired by the predetermined imaging device, changing setting for performing the face region detection process with the image data acquired by the predetermined imaging device and performing detection of a face region, and thereafter, changing the setting for performing the face region detection process with the image data acquired by the other imaging device.

### (Supplementary Note 6)

The detection method according to Supplementary Note 5, comprising

in a case where a face region cannot be detected based on the image data acquired by the predetermined imaging device, changing setting of a region estimated based on a result of detection of a posture of a person, and also performing detection of a face region on the region estimated based on the result of the detection of the posture of the person.

### (Supplementary Note 7)

The detection method according to any one of Supplementary Notes 1 to 6, comprising

in a case where there are a plurality of other imaging devices, estimating an imaging device located ahead in an advancing direction of a person based on a result of detection of a posture of the person, and changing setting for performing the face region detection process with image data acquired by the estimated imaging device.

### (Supplementary Note 8)

The detection method according to any one of Supplementary Notes 1 to 7, comprising

detecting a feature of a person, and instructing the imaging device to acquire image data in a state that the person is magnified based on a detected result.

### (Supplementary Note 9)

The detection method according to Supplementary Note 8, comprising

in a case where a feature of an undetected person is detected, instructing the imaging device to acquire image data in a state that the person is magnified.

### (Supplementary Note 10)

The detection method according to any one of Supplementary Notes 1 to 9, comprising:

performing face authentication based on the result of the detection of the face region; and

outputting a result of the face authentication, and information indicating an advancing direction estimated based on a result of detection of a posture of a person identified by the result of the face authentication.

### (Supplementary Note 11)

A detection apparatus comprising:

a detection unit configured to perform detection of a face region based on image data acquired by a predetermined imaging device; and

a setting change unit configured to change setting for performing a face region detection process with image data acquired by another imaging device, based on a result of the detection by the detection unit.

### (Supplementary Note 12)

The detection apparatus according to Supplementary Note 11, wherein

the setting change unit is configured to instruct the other imaging device to adjust a parameter used when the other imaging device acquires image data, based on the result of the detection by the detection unit.

### (Supplementary Note 13)

The detection apparatus according to Supplementary Note 12, wherein

the setting change unit is configured to adjust a face detection threshold value used for performing the face region detection process with the image data acquired by the other imaging device, based on the result of the detection by the detection unit.

### (Supplementary Note 14)

The detection apparatus according to any one of Supplementary Notes 11 to 13, wherein

the setting change unit is configured to, in a case where the detection unit cannot detect a face region based on the image data acquired by the predetermined imaging device, change the setting for performing the face region detection process with the image data acquired by the other imaging device.

### (Supplementary Note 15)

The detection apparatus according to any one of Supplementary Notes 11 to 14, wherein

the setting change unit is configured to, in a case where the detection unit cannot detect a face region based on the image data acquired by the predetermined imaging device, change setting for performing the face region detection process with the image data acquired by the predetermined imaging device and perform detection of a face region, and thereafter, change the setting for performing the face region detection process with the image data acquired by the other imaging device.

### (Supplementary Note 16)

The detection apparatus according to Supplementary Note 15, wherein:

the setting change unit is configured to, in a case where the detection unit cannot detect a face region based on the image data acquired by the predetermined imaging device, change setting of a region estimated based on a result of detection of a posture of a person; and

the detection unit is configured to perform detection of a face region on the region estimated based on the result of the detection of the posture of the person.

### (Supplementary Note 17)

The detection apparatus according to any one of Supplementary Notes 11 to 16, comprising

a move destination estimation unit configured to estimate an imaging device located ahead in an advancing direction of a person based on a result of detection of a posture of the person,

wherein the setting change unit is configured to change setting for performing the face region detection process with image data acquired by the imaging device estimated by the move destination estimation unit.

### (Supplementary Note 18)

The detection apparatus according to any one of Supplementary Notes 11 to 17, comprising:

a feature detection unit configured to detect a feature of a person; and

a magnification instruction unit configured to instruct the imaging device to acquire image data in a state that the person is magnified based on a result detected by the feature detection unit.

### (Supplementary Note 19)

The detection apparatus according to Supplementary Note 18, wherein

the magnification instruction unit is configured to, in a case where the detection unit detects a feature of an undetected person, instruct the imaging device to acquire image data in a state that the person is magnified.

### (Supplementary Note 20)

The detection apparatus according to any one of Supplementary Notes 11 to 19, comprising:

a face authentication unit configured to perform face authentication based on the result of the detection of the face region; and

an output unit configured to output a result of the face authentication by the face authentication unit, and information indicating an advancing direction estimated based on a result of detection of a posture of a person identified by the result of the face authentication by the face authentication unit.

### (Supplementary Note 21)

A non-transitory computer-readable recording medium having a program recorded thereon, the program comprising instructions for causing a detection apparatus to realize:

a detection unit configured to perform detection of a face region based on image data acquired by a predetermined imaging device; and

a setting change unit configured to change setting for performing a face region detection process with image data acquired by another imaging device, based on a result of the detection by the detection unit.

The program described in the example embodiments and supplementary notes is stored in a storage device, or recorded on a computer-readable recording medium. For example, the recording medium is a portable medium such as a flexible disk, an optical disk, a magnetooptical disk, and a semiconductor memory.

Although the present invention has been described above with reference to the example embodiments, the present invention is not limited to the example embodiments. The configurations and details of the present invention can be changed in various manners that can be understood by one skilled in the art within the scope of the present invention.

### DESCRIPTION OF NUMERALS

100 face authentication system
200 face authentication apparatus
210 screen display unit
220 communication IN unit
230 storage unit
231 information for detection
232 trained model
233 feature value information
234 image information
235 posture information
236 authentication result information
237 program
238 information for move destination estimation
240 operation processing unit
241 image acquisition unit
242 face region detection unit
243 posture detection unit
244 face region estimation unit
245 parameter adjustment unit
246 face authentication unit
247 output unit
300 camera
310 transmission and reception unit
320 setting unit
330 imaging unit
400 face authentication system
500 face authentication apparatus
540 operation processing unit
545 parameter adjustment unit
547 output unit
548 move destination estimation unit
600 face authentication system
700 face authentication apparatus
710 screen display unit
720 communication IN unit
730 storage unit
731 information for detection
732 authentication-related information
733 image information
734 program
740 operation processing unit
741 image acquisition unit
742 feature detection unit
743 magnification instruction unit
744 face region detection unit
745 face authentication unit
800 camera
810 transmission and reception unit
820 zoom setting unit
830 imaging unit
900 detection apparatus
901 CPU
902 ROM
903 RAM
904 programs
905 storage device
906 drive device
907 communication interface
908 input/output interface
909 bus
910 recording medium
911 communication network
921 detection unit
922 setting change unit

What is claimed is:

1. A detection method executed by a detection apparatus, the detection method comprising:
performing detection of a face region based on image data acquired by a predetermined imaging device; and
changing setting for performing a face region detection process with image data acquired by another imaging device, based on a result of the detection.

2. The detection method according to claim 1, comprising
instructing the other imaging device to adjust a parameter used when the other imaging device acquires image data, based on the result of the detection.

3. The detection method according to claim 1, comprising
adjusting a face detection threshold value used for performing the face region detection process with the image data acquired by the other imaging device, based on the result of the detection.

4. The detection method according to claim 1, comprising
in a case where a face region cannot be detected based on the image data acquired by the predetermined imaging device, changing the setting for performing the face region detection process with the image data acquired by the other imaging device.

5. The detection method according to claim 1, comprising
in a case where a face region cannot be detected based on the image data acquired by the predetermined imaging device, changing setting for performing the face region detection process with the image data acquired by the predetermined imaging device and performing detection of a face region, and thereafter, changing the setting for performing the face region detection process with the image data acquired by the other imaging device.

6. The detection method according to claim 5, comprising
in a case where a face region cannot be detected based on the image data acquired by the predetermined imaging device, changing setting of a region estimated based on a result of detection of a posture of a person, and also performing detection of a face region on the region estimated based on the result of the detection of the posture of the person.

7. The detection method according to claim 1, comprising
in a case where there are a plurality of other imaging devices, estimating an imaging device located ahead in an advancing direction of a person based on a result of detection of a posture of the person, and changing setting for performing the face region detection process with image data acquired by the estimated imaging device.

8. The detection method according to claim 1, comprising
detecting a feature of a person, and instructing the imaging device to acquire image data in a state that the person is magnified based on a detected result.

9. The detection method according to claim 8, comprising
in a case where a feature of an undetected person is detected, instructing the imaging device to acquire image data in a state that the person is magnified.

10. The detection method according to claim 1, comprising:
performing face authentication based on the result of the detection of the face region; and
outputting a result of the face authentication, and information indicating an advancing direction estimated based on a result of detection of a posture of a person identified by the result of the face authentication.

11. A detection apparatus comprising:
at least one memory configured to store instructions; and
at least one processor configured to execute the instructions to:
perform detection of a face region based on image data acquired by a predetermined imaging device; and
change setting for performing a face region detection process with image data acquired by another imaging device, based on a result of the detection.

12. The detection apparatus according to claim 11, wherein the at least one processor is configured to execute the instructions to
instruct the other imaging device to adjust a parameter used when the other imaging device acquires image data, based on the result of the detection.

13. The detection apparatus according to claim 12, wherein the at least one processor is configured to execute the instructions to
adjust a face detection threshold value used for performing the face region detection process with the image data acquired by the other imaging device, based on the result of the detection.

14. The detection apparatus according to claim 11, wherein the at least one processor is configured to execute the instructions to
a face region cannot be detected based on the image data acquired by the predetermined imaging device, change the setting for performing the face region detection process with the image data acquired by the other imaging device.

15. The detection apparatus according to claim 11, wherein the at least one processor is configured to execute the instructions to
in a case where a face region cannot be detected based on the image data acquired by the predetermined imaging device, change setting for performing the face region detection process with the image data acquired by the predetermined imaging device and perform detection of a face region, and thereafter, change the setting for performing the face region detection process with the image data acquired by the other imaging device.

16. The detection apparatus according to claim 15, wherein the at least one processor is configured to execute the instructions to:
in a case where a face region cannot be detected based on the image data acquired by the predetermined imaging device, change setting of a region estimated based on a result of detection of a posture of a person; and
perform detection of a face region on the region estimated based on the result of the detection of the posture of the person.

17. The detection apparatus according to claim 11, wherein the at least one processor is configured to execute the instructions to:
estimate an imaging device located ahead in an advancing direction of a person based on a result of detection of a posture of the person; and
change setting for performing the face region detection process with image data acquired by the estimated imaging device.

18. The detection apparatus according to claim 11, wherein the at least one processor is configured to execute the instructions to:
detect a feature of a person; and
instruct the imaging device to acquire image data in a state that the person is magnified based on a detected result.

19. The detection apparatus according to claim 18, wherein the at least one processor is configured to execute the instructions to
in a case where a feature of an undetected person is detected, instruct the imaging device to acquire image data in a state that the person is magnified.

20. (canceled)

21. A non-transitory computer-readable recording medium having a program recorded thereon, the program comprising instructions for causing a detection apparatus to execute:
a process to perform detection of a face region based on image data acquired by a predetermined imaging device; and
a process to change setting for performing a face region detection process with image data acquired by another imaging device, based on a result of the detection.
